(19) United States
(12) Patent Application Publication
(10) Pub. No.: US 2024/0175461 A1
(43) Pub. Date: May 30, 2024

(54) Fasteners and Geometry for Casting Attachment

(71) Applicant: Illinois Tool Works Inc., Glenview, IL (US)

(72) Inventors: Mark Beyer, Troy, MI (US); Chad M. Clark, Stamping Ground, KY (US)

(21) Appl. No.: 18/510,255

(22) Filed: Nov. 15, 2023

Related U.S. Application Data
(60) Provisional application No. 63/428,162, filed on Nov. 28, 2022.
(60) Provisional application No. 63/433,541, filed on Dec. 19, 2022.

(51) Int. Cl. F16B 37/08; F16B 5/02; F16B 5/06

(52) U.S. Cl. CPC F16B 37/0842; F16B 5/02; F16B 5/0657

(57) ABSTRACT

Disclosed is a retainer to couple a first component to a second component having a rib via a male fastener. The retainer includes a body portion, one or more tabs coupled to the body portion; and retention clips resiliently coupled to the body portion. The body portion includes or defines a female fastener to receive the male fastener. The one or more tabs and at least one of the plurality of retention clips cooperate to define a cavity to receive the rib. The plurality of retention clips is arranged to engage and retain the rib within the cavity. In some examples, the retainer is a stamped retainer clip.

### CROSS-REFERENCE

The present application claims priority to U.S. Provisional Patent Application No. 63/428,162, filed Nov. 28, 2022, and also claims priority to U.S. Provisional Patent Application No. 63/433,541, filed Dec. 19, 2022, both entitled “Fasteners and Geometry for Casting Attachment,” which are hereby incorporated by reference in their entireties.

### BACKGROUND

Automotive components require fastening techniques that are simple to manufacture and assemble. Further, fastening techniques should above all be reliable and efficient. A retainer clip can be used to make a connection between components, such as automotive panels.

While the applications can vary greatly, such retainer clips are sometimes used to attach one component (e.g., a panel) to another component (e.g., a frame or other support structure). For example, in the context of automotive manufacturing, a frame is a structure that serves as a backbone of a vehicle or component thereof, providing support and a rigid structure to which other components, such as the engine, suspension, interior components, and body panels, are attached. Traditionally, such frames and other vehicular support structures were fabricated using metal tubing (e.g., square or rectangular tubing) and/or sheet metal that is bent, welded, and/or otherwise joined to one another to form a frame or other support structure. Often, these structures would include one or more openings configured to receive a retainer clip.

In recent years, however, there has been a shift from tubular and/or sheet metal based structures to structures to cast structures. A cast structure, in an automotive context, refers to a vehicle frame or chassis that is produced using a casting process. The choice of metal for casting can vary but often includes materials like iron or aluminum. Given the nature of cast structures, manufacturers are less inclined to cut, drill, or otherwise form openings configured to receive a retainer clip.

Therefore, despite advancements to date, it would be highly desirable to have a retainer clip that is configured to attach to a structure without requiring an opening formed therein.

### SUMMARY

The present disclosure relates generally to a fastening system to form a connection between two components, such as vehicular components, using a retainer clip, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates an isometric assembly view of the fastening system in accordance with an aspect of this disclosure.

FIG. 1b illustrates an assembled isometric view of the fastening system.

FIG. 1c illustrates an elevation assembly view of the fastening system.

FIG. 1d illustrates an elevation assembled view of the fastening system.

FIG. 2a illustrates a first topside isometric view of the retainer clip of FIGS. 1a through 1d.

FIG. 2b illustrates a second topside isometric view of the retainer clip.

FIGS. 2c through 2f illustrate first, second, third, and fourth side elevation views of the retainer clip.

FIG. 2g illustrates a top plan view of the retainer clip.

FIG. 2h illustrates a bottom plan view of the retainer clip.

FIG. 2i illustrates a cross-sectional view of an assembled fastening system taken along cut line A-A (FIG. 1b).

FIG. 3a illustrates an isometric assembly view of the fastening system using a doghouse structure in accordance with another aspect of this disclosure.

FIG. 3b illustrates an assembled isometric view of the fastening system.

FIG. 3c illustrates an elevation assembly view of the fastening system.

FIG. 3d illustrates an elevation assembled view of the fastening system.

FIG. 4a illustrates a first topside isometric view of a retainer clip of FIGS. 3a through 3d.

FIG. 4b illustrates a second topside isometric view of the retainer clip.

FIGS. 4c through 4f illustrate first, second, third, and fourth side elevation views

of the retainer clip.

FIG. 4g illustrates a top plan view of the retainer clip.

FIG. 4h illustrates a bottom plan view of the retainer clip.

FIG. 4i illustrates a cross-sectional view of an assembled fastening system taken along cut line B-B (FIG. 3b).

FIG. 5 illustrates a first topside isometric view of a retainer clip in accordance with yet another aspect of this disclosure.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Disclosed is a retainer clip configured to attach to a structure without requiring an opening formed therein. In some examples, the retainer clips can be captured at one end in an opening or doghouse structure of a first component and packaged as a part-in-assembly (PIA).

In one example, In one example, a retainer to couple a first component to a second component having a rib via a male fastener comprises: a body portion having formed therein a female fastener, wherein the female fastener is configured to receive the male fastener; one or more tabs coupled to the body portion; and a plurality of retention clips resiliently coupled to the body portion, wherein the one or more tabs and at least one of the plurality of retention clips cooperate to define a cavity configured to receive the rib, and wherein the plurality of retention clips is arranged to engage and retain the rib within the cavity.

In another example, a retainer assembly to couple a first component having an opening to a second component having a rib comprises: a male fastener configured to pass at least partially through the opening formed in the first component; and a retainer having a body portion, one or more tabs, and a plurality of retention clips, wherein a female fastener is formed in the body portion and is configured to receive the male fastener; wherein the plurality of retention clips is resiliently coupled to the body portion, wherein the one or more tabs and at least one of the plurality of retention clips cooperate to define a cavity configured to receive the rib, and wherein the plurality of retention clips is arranged to engage and retain the rib within the cavity.

In yet another example, a retainer to couple a first component to a second component having a rib via a male fastener comprises: a body portion having formed therein a female fastener, wherein the female fastener is shaped as a collar with a plurality of grooves formed on an inner sidewall surface thereof and configured to receive the male fastener; one or more tabs coupled to the body portion; and a first retention clip, a second retention clip, and a third retention clip resiliently coupled to the body portion, wherein the first retention clip and the third retention clip are configured to pinch, scrape, dig into, or otherwise grip the rib to mitigate pullout, and wherein the first retention clip and the second retention clip cooperate to define a flared opening to the cavity configured to guide a distal end of the rib into the cavity.

In some examples, the female fastener is shaped as a collar with a plurality of grooves formed on an inner sidewall surface thereof.

In some examples, the body portion defines a set of shoulders configured to engage a doghouse structure.

In some examples, the plurality of retention clips defines a set of clips guide members configured to guide a distal end of the rib into the cavity.

In some examples, the clip tab is canted into the cavity and configured to engage the rib. In some examples, the retainer is a stamped retainer clip.

In some examples, the plurality of retention clips comprises a first retention clip, a second retention clip, and a third retention clip. The first retention clip can comprise a clip tab formed therein. The first retention clip and the third retention clip can be configured to pinch, scrape, dig into, or otherwise grip the rib to mitigate pullout. The first retention clip and the second retention clip can cooperate to define a flared opening to the cavity configured to guide a distal end of the rib into the cavity.

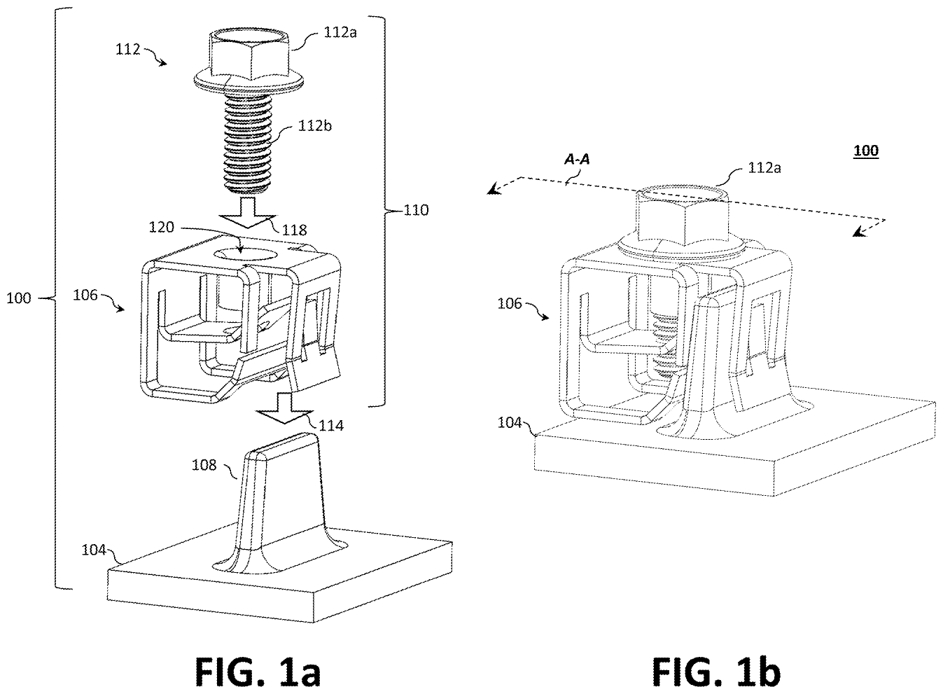

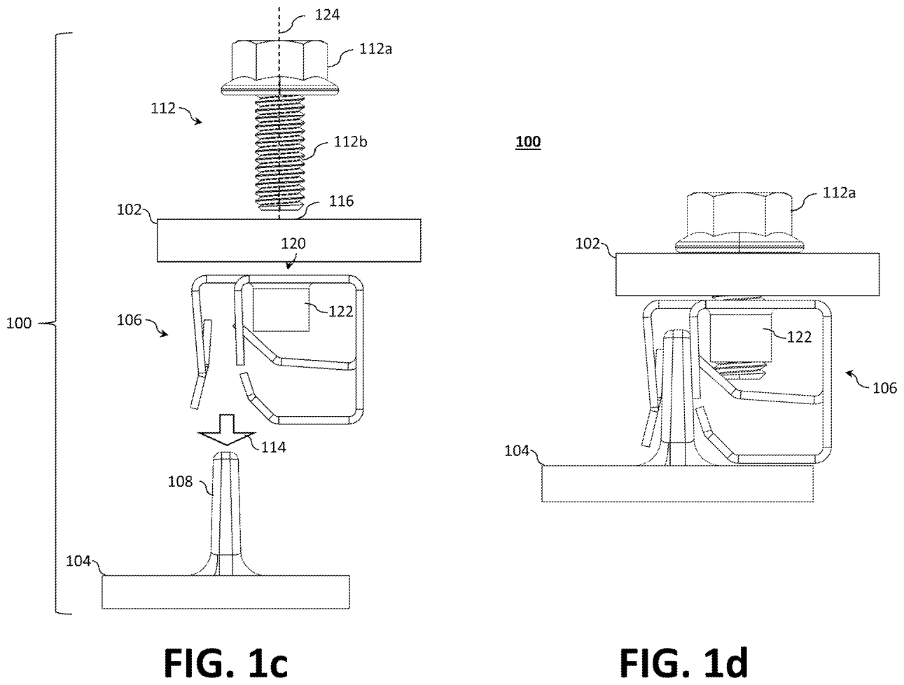

FIGS. 1a through 1d illustrate a fastening system 100 configured to couple a first component 102 relative to a second component 104 via a retainer clip 106 in accordance with an aspect of this disclosure. The first component 102 is omitted from Figures la and 1b for illustrative purposes, but is illustrated in FIGS. 1c and 1d. More specifically, Figure la illustrates an isometric assembly view of the fastening system 100 in accordance with an aspect of this disclosure, while FIG. 1b illustrates an assembled isometric view of the fastening system 100. FIG. 1c illustrates an elevation assembly view of the fastening system 100 in accordance with an aspect of this disclosure, while FIG. 1d illustrates an elevation assembled view of the fastening system 100.

The illustrated fastening system 100 includes the first component 102, the second component 104, and a retainer assembly 110. The retainer assembly 110 is configured to join the first component 102 and the second component 104. To facilitate attachment via the retainer assembly 110, each of the first component 102 and the second component 104 can include one or more engagement features. For example, the first component 102 is illustrated as having an opening 116 formed therein and the second component 104 is illustrated as having one or more ribs 108 from on a surface thereof. For example, the one or more ribs 108 protrude perpendicularly from a surface of the second component 104, which may be a cast structure.

The opening 116 can be formed in the first component 102 during manufacturing thereof or added post-manufacture through a mechanical process (e.g., drilling, cutting, carving, etc.). Each rib 108 (sometimes called a blade, tower or protrusion) may be shaped as a planar tab or continuous ridge. Depending on the material type, the one or more ribs 108 may be formed during casting, molding, or layup of the second panel 104, or attached after fabrication (e.g., using adhesive or mechanical fasteners). After the first component 102 and the second component 104 are assembled, as best illustrated in FIGS. 1b and 1d, the second component 104 is covered at least partially by the first component 102.

The retainer assembly 110 is illustrated as a multi-component retainer clip assembly having a male fastener 112 (e.g., a fastener head 112a with an externally-threaded shank 112b, such as a bolt) and a retainer clip 106 (e.g., a metal retainer clip), The retainer clip 106 defines or otherwise comprise a female fastener 122 (e.g., an internally-threaded component, such as a threaded collar). The retainer clip 106 is configured to mechanically engage and couple with the first component 102 via the male fastener 112 passing through the opening 116 to engage the female fastener 122. The retainer clip 106 is configured to mechanically engage and couple with the second component 104 via the rib 108 and, as will be discussed, engagement features formed on the retainer clip 106.

It is contemplated that certain components of the retainer assembly 110 may be fabricated as a stamped-metal component using a metal-stamping technique. For example, the retainer clip 106 can be fabricated from a single sheet of metal and stamped/bent using a metal-stamping technique, while the male fastener 112 can be fabricated from metal via one or more metal-shaping techniques, such as cold forging. In another example, the retainer clip 106 can be fabricated as a stamped-metal component, whereas the male fastener 112 can be fabricated from a plastic material using a plastic injection technique, additive manufacturing, or otherwise. To is contemplated, however, that the retainer clip 106 could also be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process.

The first component 102 and the second component 104 may be, for example, automotive panels or other automotive components. Depending on the application, one or both of the first component 102 and/or the second component 104 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof. In the automotive industry, example first components 104 include, without limitation, door trim panels, moldings, trim pieces, and other substrates (whether used as interior or exterior surfaces). The second component 104 may be, for example, a frame, an automotive panel, a structural component of a vehicle, such as doors, pillars (e.g., an A-pillar, B-pillar, C-pillar, etc.), dashboard components (e.g., a cross member, bracket, frame, etc.), seat frames, center consoles, fenders, sheet metal framework, or the like. Depending on the application, the first component 102 and/or the second component 104 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof. In some examples, one or both if the first component 102 and the second component 104 are formed using a casting process, which involves pouring molten metal into a mold to create the desired shape. In the case of a cast automotive frame, the metal is typically cast into a mold that represents the frame's structure.

The retainer 106 can be attached to the rib 108 vertically. During installation, as best illustrated in FIGS. 1a and 1c, the retainer clip 106 is slid over the rib 108 of the second component 102 as indicated by arrow 114 and to engage the rib 108 via an interference fit. Once the retainer clip 106 is installed, an end of the male fastener 112 is passed through both the opening 116 formed in the first component 102 and an opening 120 formed in the retainer clip 106 as indicated by arrow 118 to ultimately to access and engage the female fastener 122.

The male fastener 112 can be rotated relative to the female fastener 122 about its axis of rotation 124 to join and compress the first component 102 relative to the retainer clip 106. As will be described in greater detail, the retainer clip 106 includes one or more engagement features to attach or otherwise engage the first component 102 and/or second component 104. During assembly/disassemble, the male fastener 112 and the female fastener 122 utilize the rib 108 for anti-rotation to achieve bolt or stud torque.

In the illustrated example, the male fastener 112 is a threaded bolt with a hex-shaped head, but other types of fasteners are contemplated. In some examples, the retainer clip 106 may comprise a seal when desirable to mitigate dust, dirt, and/or moisture penetration through the openings 116, 120. The seal may be embodied as a ring (e.g., an annulus) and fabricated from foam material, thermoplastic, rubber, etc. For example, a seal can be configured to surround a portion of the male fastener 112 (e.g., the shank 112b) and positioned between the fastener head 112a and the first component 102 and/or between the first component 102 and the retainer clip 106.

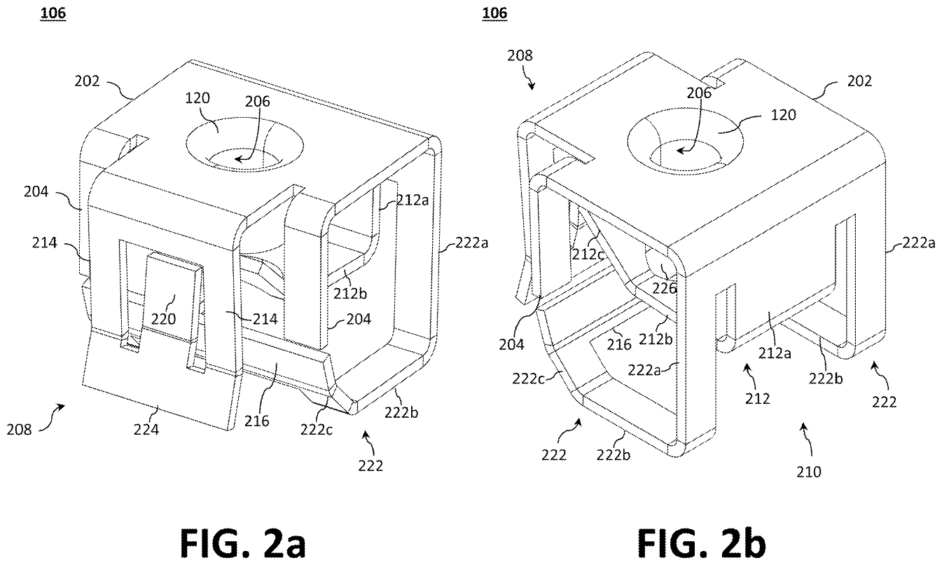

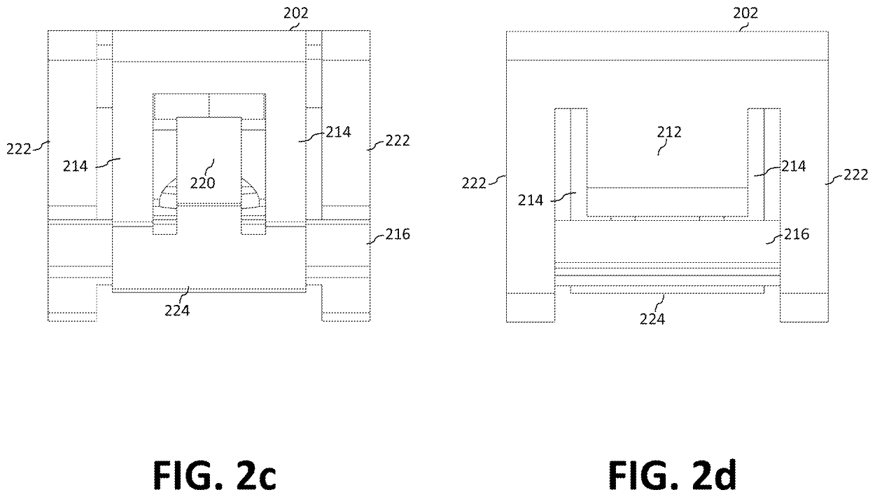

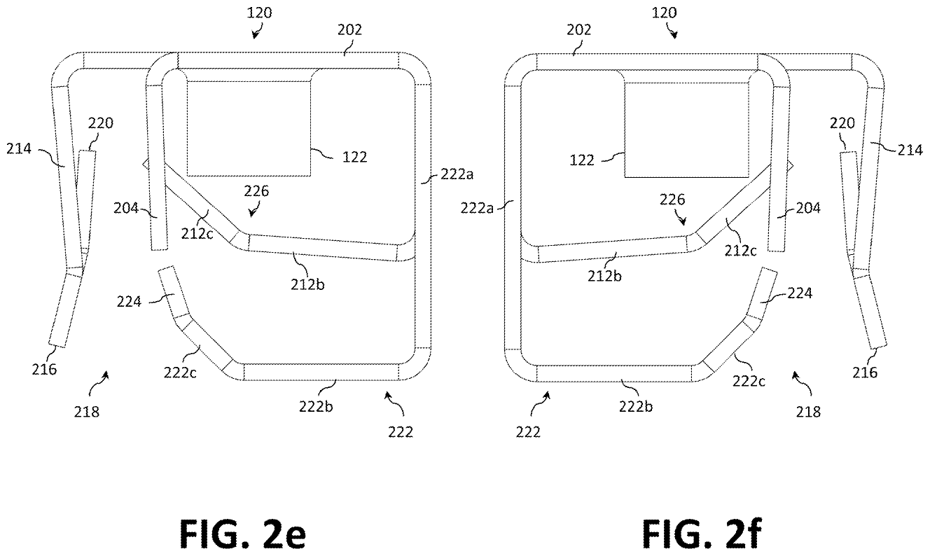

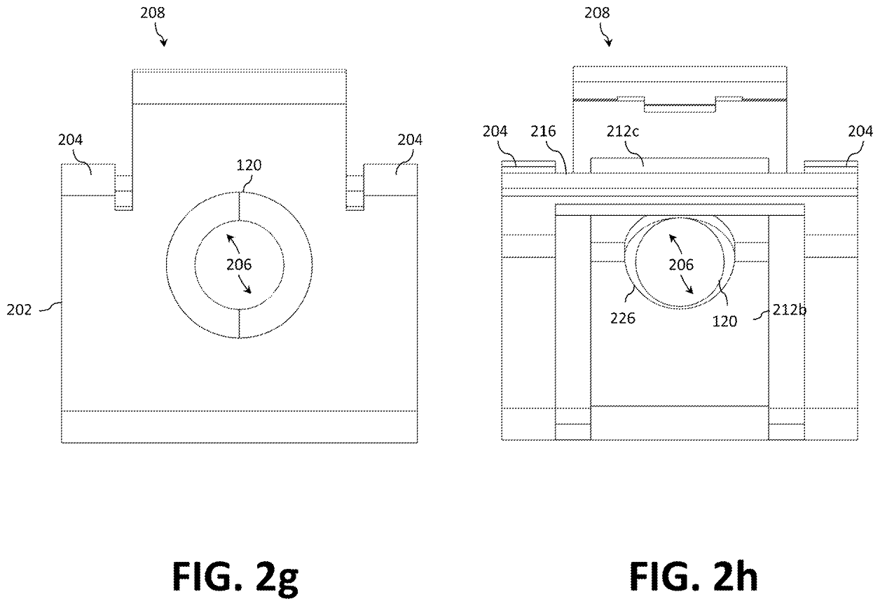

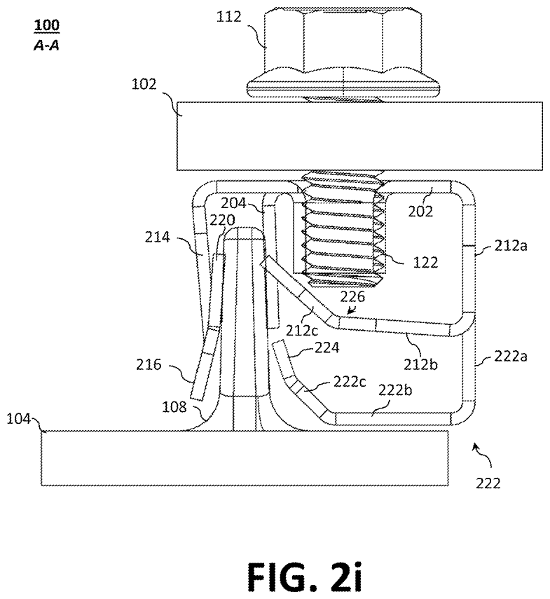

FIGS. 2a and 2b illustrate, respectively, first and second topside isometric views of the retainer clip 106 of FIGS. 1a through 1d, while FIGS. 2c through 2f illustrate first, second, third, and fourth side elevation views of the retainer clip 106. FIGS. 2g and 2h illustrate, respectively, top and bottom plan views of the retainer clip 106. FIG. 2i illustrates a cross-sectional view of an assembled fastening system 100 taken along cut line A-A (FIG. 1b). Once advantage of the disclosed retainer 106 is that it provides a serviceable attachment between the first component 102 and the second component 104 that have one or more ribs 108 (such as plastic or cast materials). The retainer 106 may be fabricated in various sizes depending on the application.

The retainer 106 may be a stamped retainer clip. For example, a flat sheet of metal may be stamped (e.g., die stamped) to define the outer perimeter, profile, and cutouts to define the various features of the retainer 106. After stamping, the flat sheet of metal may be bent along one or more lines or at one of more points through one or more steps to define the retainer 106.

As illustrated, the retainer 106 generally comprises a body portion 202, a pair of tabs 204, and a plurality of resiliently-attached retention clips. As used herein, components or portions of the retainer clip 106 are said to be resiliently connected when the components or portions default (e.g., spring back) to a predetermined shape. For example, during assembly, the components or portions may be biased (e.g., pushed) inward and/or outward, but, in the absence of such external forces, return to the default shape.

In the illustrated example, the body portion 202 is generally planar and, upon assembly, configured to abut an underside of the first component 102. The body portion 202 defines the opening 120 through which the male fastener 112 passes to engage the female fastener 122. In the illustrated example, the female fastener 122 is shaped as a collar with a plurality of grooves formed on the inner sidewall surface 206. The plurality of grooves correspond to the externally-threaded shank 112b. A noted above, the retainer 106 can be fabricated from a single sheet of metal that is stamped, bent, and extruded to form the body portion 202, a pair of tabs 204, and a plurality of resiliently attached clips; therefore, while described as separate elements, the retainer 106 can remain a single, integrated structure.

In the illustrated example, the body portion 202 is coupled to a plurality of resiliently-attached retention clips, including a first retention clip 208, a second retention clip 210, and a third retention clip 212. In operation, the first retention clip 208, the second retention clip 210, and the third retention clip 212 cooperate to engage and attach to the rib 108. For example, one or more of the first retention clip 208, the second retention clip 210, and the third retention clip 212 can include one or more clip tabs to pinch, scrape, dig into, or otherwise grip the rib 108. For example, as will be discussed, the retainer 106 can engage the rib 108 by one or more clip tabs digging into the rib 108, or a through-window can be placed in the rib 108 for the one or more tabs to snap into or otherwise engage to yield an even higher retention. In addition, the retainer 106 has features for stabilizing it against the rib 108 in addition to one or more tabs digging in, such as a pair of tabs 204. The illustrated pair of tabs 204 are substantially perpendicular to the body portion 202.

The illustrated first retention clip 208 comprises a leg 214 and a guide member 216. The leg 214 can be parallel to the pair of tabs 204 or, as illustrated, canted inward toward the pair of tabs 204 to help pinch the rib 108. In some examples, the leg 214 can be canted inward toward the pair of tabs 204 by an angle that is 2 to 15 degrees, or about 5 to 10 degrees. As best illustrated in FIGS. 2e, 2f, and 2i, the leg 214 and the pair of tabs 204 define a cavity 218 configured to receive and, ultimately, retain the rib 108.

The leg 214 further comprises a clip tab 220 formed therein (e.g., via a die punch) that is canted inward (i.e., into the cavity 218). The guide member 216 is angled to help guide a distal end of the rib 108 into the cavity 218. During and post assembly, the clip tab 220 is configured to pinch, scrape, dig into, or otherwise grip the rib 108 to mitigate pullout.

The illustrated second retention clip 210 comprises a pair of legs 222 and a guide member 224. In some examples, each of the pair of legs 222 is bent at one or more locations along its length to define a side profile that is generally J-shaped. In the illustrated example, each leg 222 defines a first linear segment 222a, a second linear segment 222b, and a third linear segment 222c. Each of the pair of legs 222 is resiliently coupled to the body portion 202 at a first end (e.g., via the first linear segment 222a) and to the guide member 224 at a second end (e.g., via the third linear segment 222c). As illustrated, each end of the guide member 224 is coupled to a leg 222 via its third linear segment 222c. The guide member 224 is substantially perpendicular to the third linear segments 222c. The guide member 224 is angled to help guide a distal end of the rib 108 into the cavity 218. As best illustrated in FIGS. 2e and 2f, the guide members 216, 224 cooperate to define a flared opening to the cavity 218, thus allowing for a degree of misalignment during assembly as the guide members 216, 224 guide the distal end of the rib 108 into the cavity 218. The flexible nature of the retainer 106 and angles of the guide members 216, 224 permit a relatively low insertion force required to insert the rib 108 into the retainer 106. In some example, the insertion force may be about two pounds. The second linear segment 222b is substantially parallel to the body portion 202 and, in some examples, can serve as a base that contacts the second component 104 to increase stability.

The illustrated third retention clip 212 is bent at one or more locations along its length to define a first linear segment 212a, a second linear segment 212b, and a third linear segment 212c, which serves as a clip tab. As best illustrated in FIG. 2i, the third linear segment 212c cooperates with the clip tab 220 to pinch, scrape, dig into, or otherwise grip the rib 108 to mitigate pullout. As illustrated in FIG. 2b, the material use to form the third retention clip 212 can be punched from the second retention clip 210 (e.g., the area bounded by the material used to form the pair of legs 222 and the guide member 224). In some examples, the third retention clip 212 comprises a fastener pass-through opening 226 to allow the distal end of the shank 112b of the male fastener 112 to pass through the third retention clip 212 when tightened without interfering with or otherwise affecting the third retention clip 212. In other examples, the fastener pass-through opening 226 can be omitted such that the male fastener 112 engages the third retention clip 212 to bias it in a desired manner.

In the illustrated example, the retainer 106 defines a clip tab 220 and a third linear segment 212c that engages the rib 108; however, it is to be understood that the retainer 106 may comprise any number of components that engage the rib 108. For example, two or more clip tabs 220 and/or two or more third linear segments 212c. Further, in some examples, one or more features can be formed in or on the surface of the rib 108 to increase friction. For example, the rib 108 may comprise one or more bumps, recesses, apertures, or ledges to increase friction between the rib 108 and the clip tab 220, the third linear segment 212c, etc.

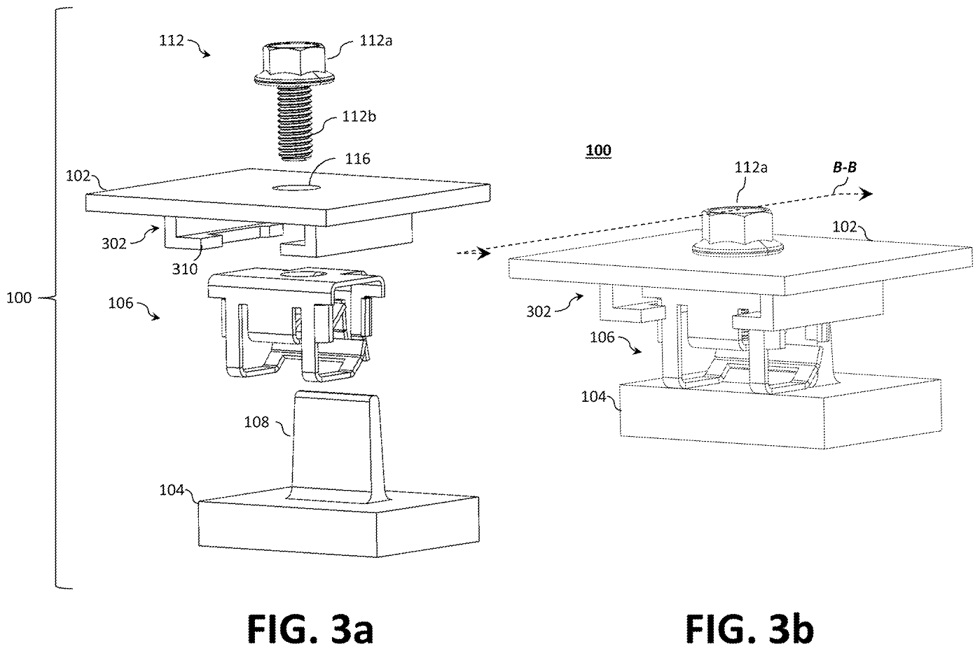

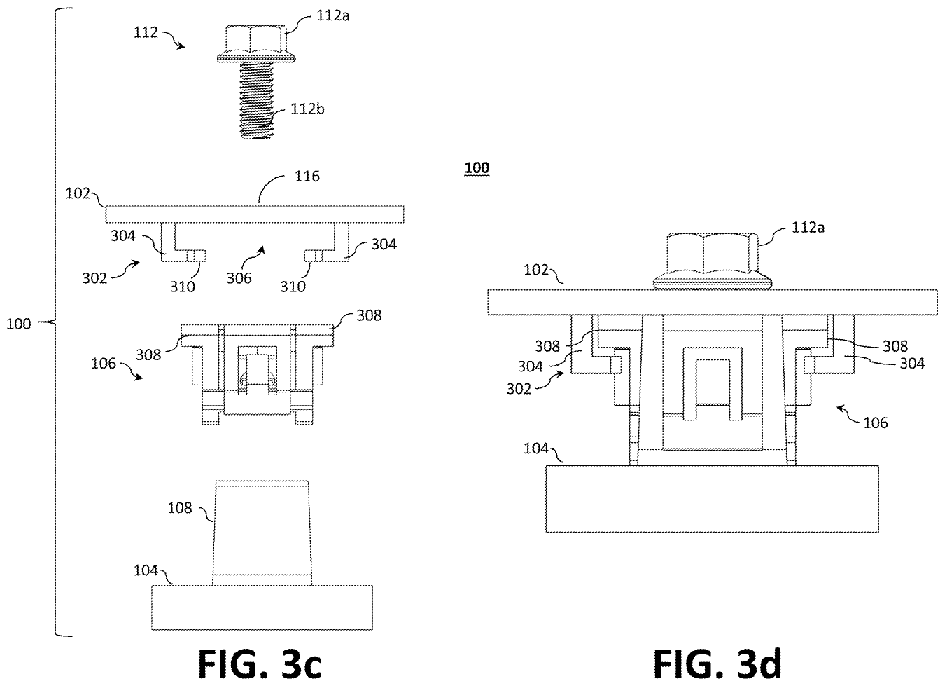

FIGS. 3a through 3d illustrate a fastening system 100 configured to couple a first component 102 relative to a second component 104 via a retainer clip 106 using a doghouse structure in accordance with another aspect of this disclosure. More specifically, FIG. 3a illustrates an isometric assembly view of the fastening system 100 in accordance with an aspect of this disclosure, while FIG. 3b illustrates an assembled isometric view of the fastening system 100. FIG. 3c illustrates an elevation assembly view of the fastening system 100 in accordance with an aspect of this disclosure, while FIG. 3d illustrates an elevation assembled view of the fastening system 100.

The fastening system 100 of FIGS. 3a through 3d is substantially the same as the fastening system 100 of Figures la through 1d except that the retainer clip 106 of FIGS. 3a through 3d is configured to further engage the first component 102 via a doghouse structure 302. Therefore, in this example, the retainer clip 106 defines a set of shoulders 308, while the first component 102 may include or define, the doghouse structure 302. A doghouse structure 302 allows for the first component 102 to be used with a wide variety of fasteners, including the retainer clip 106. In addition, the retainer clip 106 can be preinstalled on the first component 102 via the doghouse structure 304 to be packaged and shipped as a part-in-assembly (PIA), thus reducing time and effort needed during assembly by an end-user.

As illustrated, the doghouse structure 302 is composed of a set of doghouse sidewalls 304 defining the receptacle 306 therebetween. The receptacle 306 is size and shaped to receive a portion of the retainer clip 106. The doghouse sidewalls 304 may include one or more features shaped to increase engagement with the retainer clip 106 and/or serve as stops for the retainer clip 106, such as interference features 310 that engage the set of shoulders 308. In some examples, the interference features 310 may exhibit a soft click as the retainer clip 106 is secured in the receptacle 306. The doghouse structure 302 may be molded during molding of the first component 102; however, in some examples, they may be fabricated separately and later joined to one another (e.g., using adhesive, mechanical fasteners, etc.). The doghouse structure 302 is contemplated to be modified in size and shape to suit individual applications. For example, while illustrated with two opposing doghouse sidewalls 304, in some examples, the doghouse structure 302 may further include a doghouse end wall formed to bridge the gap between the set of doghouse sidewalls 304.

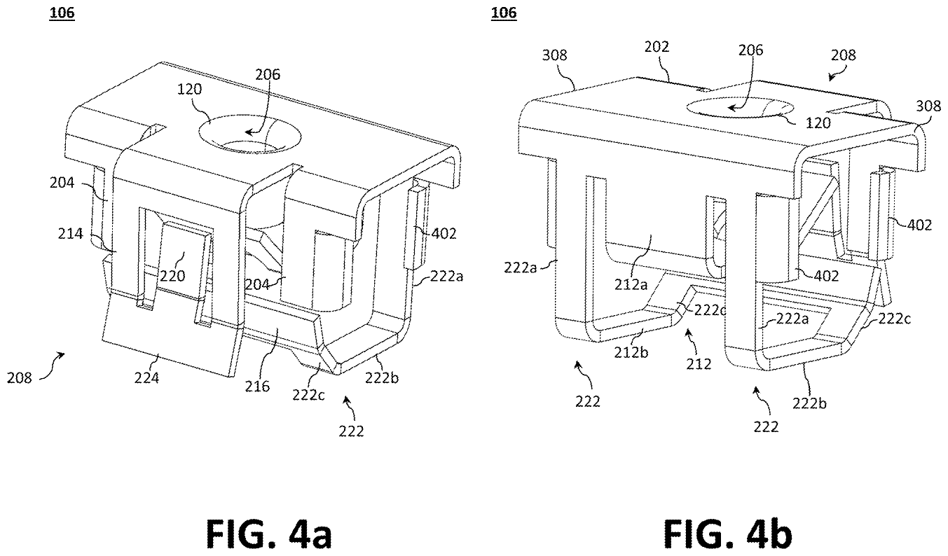

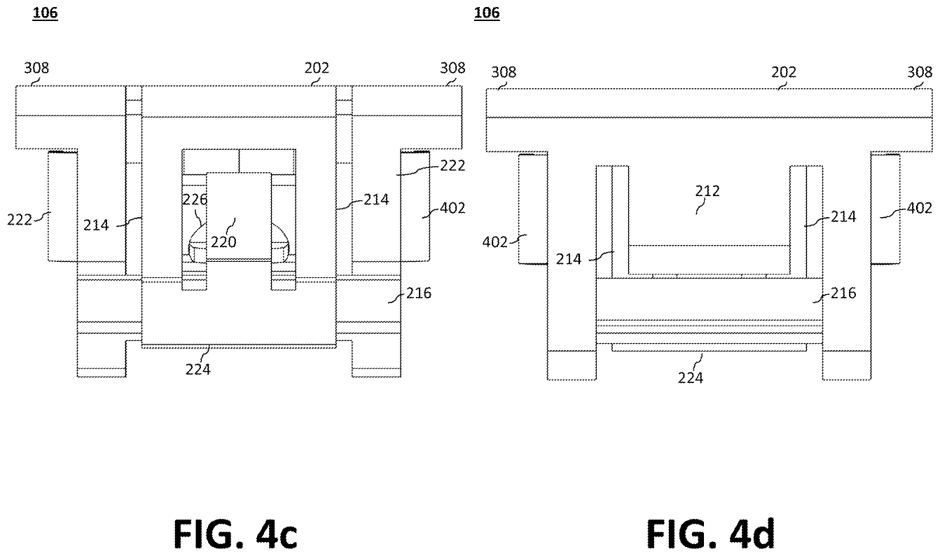

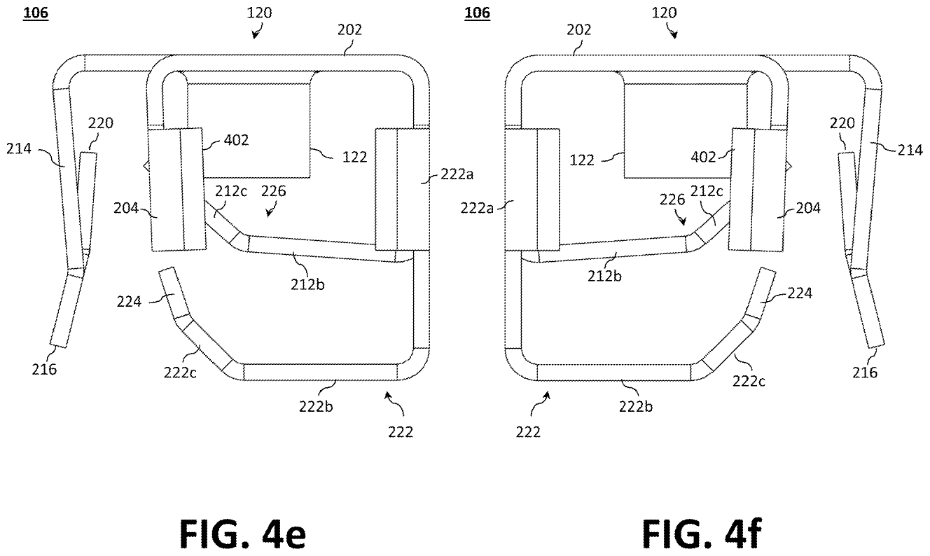

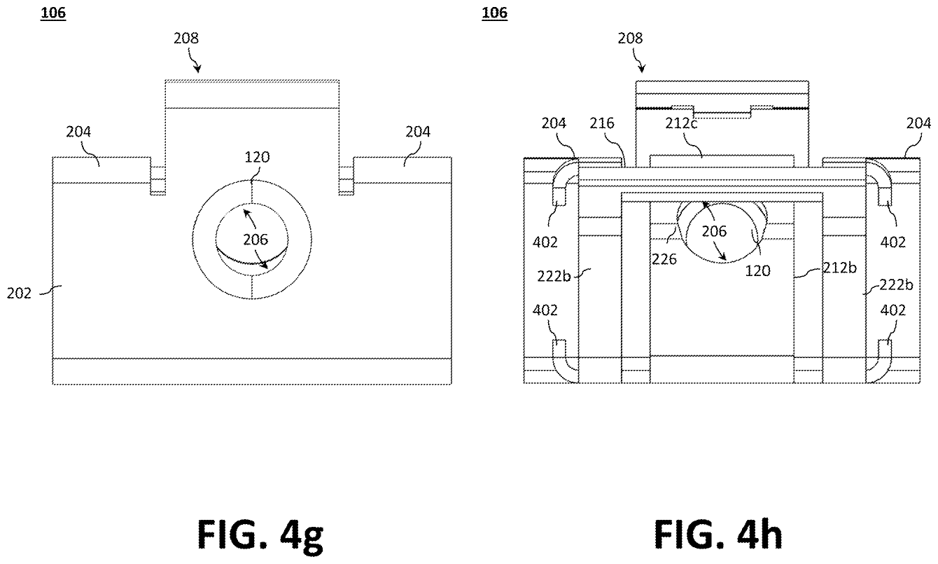

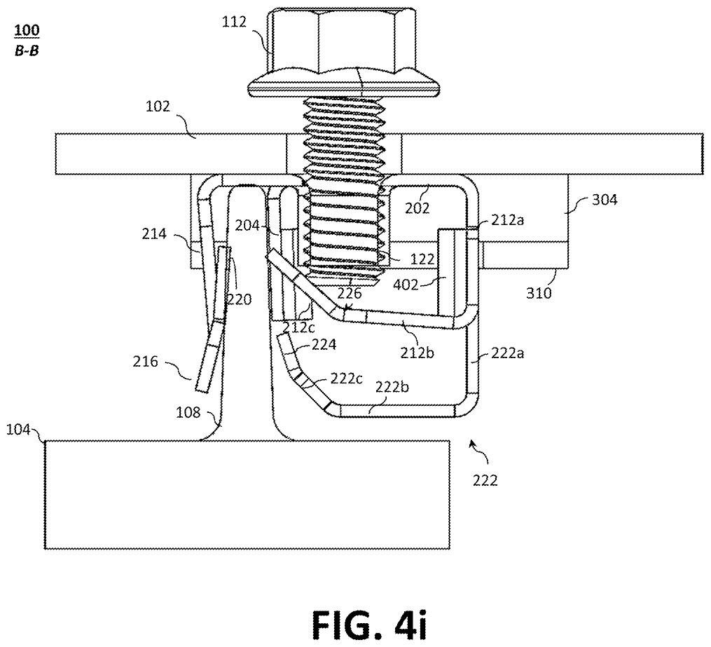

FIGS. 4a and 4b illustrate, respectively, first and second topside isometric views of the retainer clip 106 of FIGS. 3a through 3d, while FIGS. 4c through 4f illustrate first, second, third, and fourth side elevation views of the retainer clip 106. FIGS. 4g and 4h illustrate, respectively, top and bottom plan views of the retainer clip 106. FIG. 4i illustrates a cross-sectional view of an assembled fastening system 100 taken along cut line B-B (FIG. 3b).

The retainer clip 106 of FIGS. 4a through 4i is substantially the same as the retainer clip 106 of FIGS. 2a through 2i except that the retainer clip 106 of FIGS. 4a through 4i comprises the set of shoulders 308 configured to engage the doghouse structure 302 once the retainer clip 106 is position in the receptacle 306. In addition, a portion of each of the pair of tabs 204 is bent (e.g., by 90 degrees in the illustrated example) to define a flange 402 that is configured to mitigate rattling, scraping, and/or damage to the first component 102 and/or doghouse structure 302 when inserted and/or housed within the doghouse structure 302.

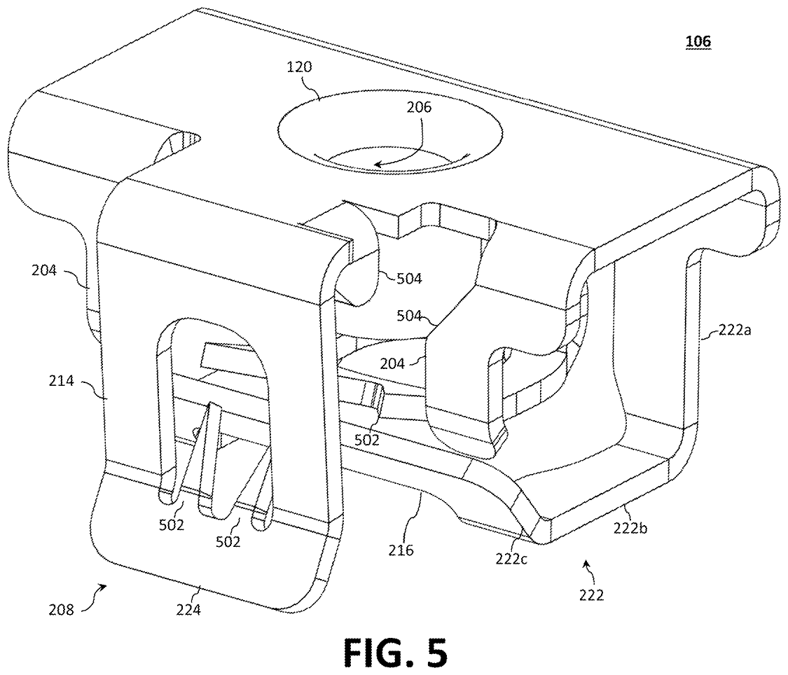

FIG. 5 illustrates a topside isometric view of a retainer clip 106 in accordance with yet another aspect of this disclosure. The retainer clip 106 of FIG. 5 is substantially the same as the retainer clip 106 of FIGS. 4a through 4i except that the retainer clip 106 of FIG. 5 comprises one or more barbs 502 in addition to or in lieu of the flat edges of the above-described clip tab 220 and the third linear segment 212c. The one or more barbs 502 enable the first retention clip 208 and the second retention clip 210 to pinch, scrape, dig into, or otherwise grip the rib 108 more aggressively. The retainer clip 106 further comprises one or more alignment features 504 to serve as, for example, a poke-yoke feature to prevent or mitigate human error during assembly. For example, the one or more alignment features 504 can be configured to engage a corresponding slot or depression in or on the rib 108, which could be useful in instances where the retainer clip 106 is installed onto rib 108 prior to installation of the first component 102. In the illustrated example, the alignment features 504 ensures that the retainer clip 106 is installed in the correct orientation, and not 180° from the intended orientation.

In some examples, a method of manufacturing a retainer 106 to couple a first panel 102 to a second panel 104 would start with stamping a sheet of metal to form a die cutout for the retainer 106. The die cutout is generally planar and resides in a plane (e.g., a single plane) and is shaped to define portions that correspond to the various components of the retainer 106, such as the body portion 202, the pair of tabs 204, and the plurality of resiliently-attached retention clips. The sheet of metal may be stamped via a press and die. In other examples, the die cutout may be cut from sheet of metal using lasers, water jets, jigsaw, etc. Next, the various features are bent along multiple fold lines during multiple steps to produce the retainer 106.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A retainer to couple a first component to a second component having a rib via a male fastener, the retainer comprising:
a body portion having formed therein a female fastener,
wherein the female fastener is configured to receive the male fastener;
one or more tabs coupled to the body portion; and
a plurality of retention clips resiliently coupled to the body portion,
wherein the one or more tabs and at least one of the plurality of retention clips cooperate to define a cavity configured to receive the rib, and
wherein the plurality of retention clips is arranged to engage and retain the rib within the cavity.

2. The retainer of claim 1, wherein the female fastener is shaped as a collar with a plurality of grooves formed on an inner sidewall surface thereof.

3. The retainer of claim 1, wherein the body portion defines a set of shoulders configured to engage a doghouse structure.

4. The retainer of claim 1, wherein the plurality of retention clips defines a set of clips guide members configured to guide a distal end of the rib into the cavity.

5. The retainer of claim 1, wherein the plurality of retention clips comprises a first retention clip, a second retention clip, and a third retention clip.

6. The retainer of claim 5, wherein the first retention clip comprises a clip tab formed therein.

7. The retainer of claim 6, wherein the clip tab is canted into the cavity and configured to engage the rib.

8. The retainer of claim 5, wherein the first retention clip and the third retention clip are configured to pinch, scrape, dig into, or otherwise grip the rib to mitigate pullout.

9. The retainer of claim 8, wherein the first retention clip and the second retention clip cooperate to define a flared opening to the cavity configured to guide a distal end of the rib into the cavity.

10. The retainer of claim 1, wherein the retainer is a stamped retainer clip.

11. A retainer assembly to couple a first component having an opening to a second component having a rib, the retainer assembly comprising:
a male fastener configured to pass at least partially through the opening formed in the first component; and
a retainer having a body portion, one or more tabs, and a plurality of retention clips,
wherein a female fastener is formed in the body portion and is configured to receive the male fastener;
wherein the plurality of retention clips is resiliently coupled to the body portion,
wherein the one or more tabs and at least one of the plurality of retention clips cooperate to define a cavity configured to receive the rib, and
wherein the plurality of retention clips is arranged to engage and retain the rib within the cavity.

12. The retainer assembly of claim 11, wherein the female fastener is shaped as a collar with a plurality of grooves formed on an inner sidewall surface thereof.

13. The retainer assembly of claim 11, wherein the body portion defines a set of shoulders configured to engage a doghouse structure.

14. The retainer assembly of claim 11, wherein the plurality of retention clips comprises a first retention clip, a second retention clip, and a third retention clip.

15. The retainer assembly of claim 14, wherein the first retention clip comprises a clip tab that is canted into the cavity and configured to engage the rib.

16. The retainer assembly of claim 14, wherein the first retention clip and the third retention clip are configured to pinch, scrape, dig into, or otherwise grip the rib to mitigate pullout.

17. The retainer assembly of claim 16, wherein the first retention clip and the second retention clip cooperate to define a flared opening to the cavity configured to guide a distal end of the rib into the cavity.

18. The retainer assembly of claim 11, wherein the retainer is a stamped retainer clip.

19. A retainer to couple a first component to a second component having a rib via a male fastener, the retainer comprising:
a body portion having formed therein a female fastener,
wherein the female fastener is shaped as a collar with a plurality of grooves formed on an inner sidewall surface thereof and configured to receive the male fastener;
one or more tabs coupled to the body portion; and
a first retention clip, a second retention clip, and a third retention clip resiliently coupled to the body portion to define a cavity,
wherein the first retention clip and the third retention clip are configured to pinch, scrape, dig into, or otherwise grip the rib to mitigate pullout, and
wherein the first retention clip and the second retention clip cooperate to define a flared opening to the cavity configured to guide a distal end of the rib into the cavity.

20. The retainer of claim 19, wherein the body portion defines a set of shoulders configured to engage a doghouse structure.
